(19) United States
(12) Patent Application Publication
(10) Pub. No.: US 2026/0307025 A1
(43) Pub. Date: Oct. 8, 2026

(54) COATING MATERIAL-RELATED INFORMATION PROVIDING DEVICE, COATING MATERIAL-RELATED INFORMATION PROVIDING SYSTEM, COATING MATERIAL-RELATED INFORMATION PROVIDING METHOD, AND RECORDING MEDIUM

(71) Applicant: Genbe Co., Ltd., Kyoto (JP)

(72) Inventor: Kenichi SASAKI, Kyoto (JP)

(21) Appl. No.: 19/482,530

(22) PCT Filed: Aug. 19, 2024
(86) PCT No.: PCT/JP2024/029285

§ 371 Date: Nov. 7, 2025

(30) Foreign Application Priority Data
Aug. 22, 2023 (JP) 2023-135074
Feb. 26, 2024 (JP) 2024-026223
Aug. 16, 2024 (WO) PCT/JP2024/029142

(51) Int. Cl. B01F 33/84; G06V 10/22

(52) U.S. Cl. CPC B01F 33/844; B01F 33/848; G06V 10/225

(57) ABSTRACT

A cloud server (1) includes a paint information acquisition unit (111) that acquires target paint information, an overcoating possibility determination unit (114) that determines whether it is possible to overcoat any one of two types of paints on the other paint based on a classification of each solvent contained in a respective one of the two types of paints indicated by the target paint information, a thinner specifying unit (113) that specifies each thinner that can be mixed with a respective one of the two types of paints based on a solubility parameter of each of the two types of paints indicated by the target paint information, and a paint-related information notification unit (115) that generates paint-related information including overcoating possibility information indicating whether overcoating is possible and thinner information indicating the specified thinner and transmits the paint-related information to a terminal device (3).

### TECHNICAL FIELD

The present invention relates to a coating material-related information providing device, a coating material-related information providing system, a coating material-related information providing method, and a program.

### BACKGROUND ART

There has been proposed a method for presenting a coating specification, the method including: a step of providing a server system accessible from a user terminal provided for a customer and acquiring, with the server system, from the user terminal, finish data of a design layer desired by the customer and base data of a material and a degradation state of a base layer; a step of selecting, with the server system, a design paint for forming the design layer based on the finish data and determining whether a directly lower layer attachable to the design paint is identical to the base layer; and a step of indicating, with the server system, a film structure including the design layer and the base layer and a coating specification thereof when the base layer and the directly lower layer are identical to each other (see, for example, Patent Literature 1).

### Citation List

### Patent Literature

Patent Literature 1: JP 2003-317006 A

### SUMMARY OF INVENTION

### Technical Problem

Meanwhile, it is required to suppress the occurrence of defects in a paint after coating by appropriately presenting to the user the affinity between the paint and a solvent when different paints are applied in an overlapping manner or when the paint and the solvent are mixed.

The present invention has been made in view of the above circumstances, and an object thereof is to provide a coating material-related information providing device, a coating material-related information providing system, a coating material-related information providing method, and a program capable of appropriately presenting, to a user, information on the affinity between a plurality of types of coating materials when the coating materials are applied or mixed in an overlapping manner.

### Solution to Problem

To achieve the above-described object, a coating material-related information providing device according to the present invention includes:
a coating material information acquisition unit that acquires target coating material information including first coating material information indicating a first coating material on a base side when two types of coating materials designated by a user are overcoated and second coating material information indicating a second coating material to be overcoated on the first coating material;
an overcoating determination unit that determines whether it is possible to overcoat the second coating material on the first coating material based on at least one of a classification of each solvent, a hard form of each paint, and a type of each resin contained in a respective one of the first coating material and the second coating material;
a coating material specifying unit that identifies a third coating material that can be mixed with at least one of the first coating material and the second coating material based on a solubility parameter of the at least one of the first coating material and the second coating material; and
a coating material-related information notification unit that generates coating material-related information including overcoating possibility information indicating whether the overcoating is possible and third coating material information indicating the third coating material, and transmits the coating material-related information to a terminal device.

### Advantageous Effects of Invention

According to the present invention, the overcoating determination unit determines whether the second coating material can be overcoated on the first coating material based on at least one of the classification of each solvent, the hard form of each paint, and the type of each resin contained in a respective one of the first coating material and the second coating material. The coating material specifying unit specifies the third coating material that can be mixed with at least one of the first coating material and the second coating material based on the solubility parameter of the at least one of the first coating material and the second coating material. The coating material-related information notification unit generates coating material-related information including overcoating possibility information indicating the possibility of overcoating and third coating material information and transmits the coating material-related information to the terminal device. This makes it possible to appropriately present, to the user, information on the affinity between a plurality of types of coating materials when the coating materials are applied or mixed in an overlapping manner via the coating material-related information including the overcoating possibility information and the third coating material information transmitted to the terminal device.

### BRIEF DESCRIPTION OF DRAWINGS

FIG. 1 is a diagram illustrating an example of a configuration of a paint-related information providing system according to a first embodiment of the present invention.

FIG. 2 is a block diagram illustrating a hardware configuration of a terminal device and a cloud server according to the first embodiment.

FIG. 3 is a block diagram illustrating functional configurations of the terminal device and the cloud server according to the first embodiment.

FIG. 4A is a diagram illustrating an example of information stored in a solubility parameter storage unit according to the first embodiment.

FIG. 4B is a diagram illustrating an example of information stored in a thinner information storage unit according to the first embodiment.

FIG. 5A is a diagram illustrating an example of information stored in a paint information storage unit according to the first embodiment.

FIG. 5B is a diagram illustrating an example of information stored in a determination reference storage unit according to the first embodiment.

FIG. 6 is a diagram for describing processing contents of a thinner specifying unit according to the first embodiment.

FIG. 7 is a sequence diagram for describing processing executed by the paint-related information providing system according to the first embodiment.

FIG. 8A is a diagram illustrating an example of an overcoating determination target paint input screen image displayed on a display unit of the terminal device according to the first embodiment.

FIG. 8B is a diagram illustrating an example of a paint-related information notification image displayed on the display unit of the terminal device according to the first embodiment.

FIG. 9 is a flowchart illustrating an example of paint-related information providing processing executed by the cloud server according to the first embodiment.

FIG. 10 is a block diagram illustrating functional configurations of a terminal device and a cloud server according to a second embodiment.

FIG. 11 is a sequence diagram for describing processing executed by a paint-related information providing system according to the second embodiment.

FIG. 12A is a diagram illustrating an example of a mixing determination target paint input screen image displayed on a display unit of the terminal device according to the second embodiment.

FIG. 12B is a diagram illustrating a state in which an object image is dragged with respect to the mixing determination target paint input screen image displayed on the display unit of the terminal device according to the second embodiment.

FIG. 13 is a diagram illustrating an example of a paint-related information notification image displayed on the display unit of the terminal device according to the second embodiment.

FIG. 14 is a flowchart illustrating an example of paint-related information providing processing executed by the cloud server according to the second embodiment.

FIG. 15A is a diagram illustrating an example of an overcoating determination target paint input screen image displayed on a display unit of a terminal device according to a modification.

FIG. 15B is a diagram illustrating a state in which an object image is dragged with respect to the overcoating determination target paint input screen image displayed on the display unit of the terminal device according to the modification.

FIG. 16 is a block diagram illustrating functional configurations of the terminal device and a cloud server according to the modification.

FIG. 17A is a diagram illustrating an example of a paint-related information notification image displayed on a display unit of the terminal device according to the modification.

FIG. 17B is a diagram illustrating an example of the paint-related information notification image displayed on the display unit of the terminal device according to the modification.

### DESCRIPTION OF EMBODIMENTS

### First Embodiment

Hereinafter, a coating material-related information providing device according to an embodiment of the present invention will be described with reference to the drawings. A coating material-related information providing device according to the present embodiment includes a coating material information acquisition unit, an overcoating determination unit, a coating material specifying unit, and a coating material-related information notification unit. The coating material information acquisition unit acquires target coating material information including first coating material information indicating a first coating material on the base side when two types of coating materials designated by the user are overcoated and second coating material information indicating a second coating material to be overcoated on the first coating material. The overcoating determination unit determines whether the second coating material can be overcoated on the first coating material based on at least one of the classification of each solvent, the hard form of each paint, and the type of each resin contained in a respective one of the first coating material and the second coating material. The coating material specifying unit specifies a third coating material that can be mixed with at least one of the first coating material and the second coating material based on a solubility parameter of at least one of the first coating material and the second coating material. The coating material-related information notification unit generates coating material-related information including overcoating possibility information indicating the possibility of overcoating and third coating material information indicating the third coating material, and transmits the coating material-related information to a terminal device.

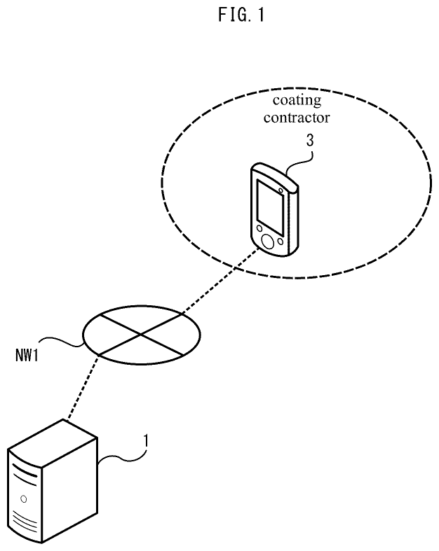

As illustrated in FIG. 1, the paint-related information providing system according to the present embodiment is a coating material-related information providing system including a terminal device 3 owned by a coating contractor and a cloud server 1, in which the terminal device 3 and the cloud server 1 can communicate with each other via a network NW1. Here, the network NW1 is, for example, the Internet.

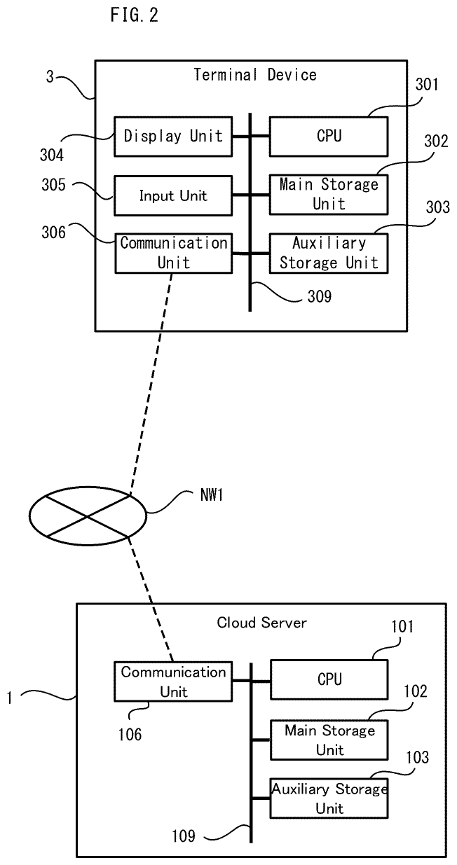

The terminal device 3 is, for example, a smartphone, and as illustrated in FIG. 2, it includes a CPU 301, a main storage unit 302, an auxiliary storage unit 303, a display unit 304, an input unit 305, a communication unit 306, and a bus 309 that connects these units to each other. The main storage unit 302 includes a volatile memory such as a RAM, and is used as a work area of the CPU 301. In addition, the main storage unit 302 includes an image-dedicated memory (not illustrated) that temporarily stores image information to be displayed on the display unit 304. The auxiliary storage unit 303 is a non-volatile memory such as a semiconductor flash memory, and it stores a program for the CPU 301 to execute various types of processing. The display unit 304 is a display device such as a liquid crystal display or an organic electro-luminescence (EL) display. The input unit 305 is, for example, a transparent touch pad disposed on the display unit 304 in an overlapping manner. The communication unit 306 is connected to the network NW1, and it transmits the information transferred from the CPU 301 to the cloud server 1 via the network NW1 and transfers various types of information acquired from the cloud server 1 via the network NW1 to the CPU 301.

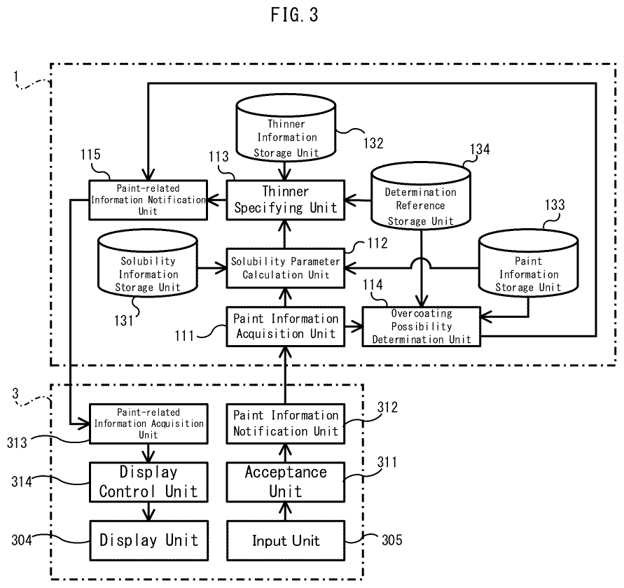

The CPU 301 functions as an acceptance unit 311, a paint information notification unit 312, a paint-related information acquisition unit 313, and a display control unit 314 as illustrated in FIG. 3 by reading the program stored in the auxiliary storage unit 303 into the main storage unit 302 and executing the program. The acceptance unit 311 accepts the operation content performed on the input unit 305 by the coating contractor possessing the terminal device 3, generates operation information corresponding to the accepted operation content, and notifies the paint information notification unit 312 of the operation information. Specifically, when the coating contractor performs a target paint information input operation of inputting the paint name of the paint to be used for the lower layer of the two types of paints to be overcoated and the paint name of the paint to be used for the upper layer on the lower layer with respect to the input unit 305, the acceptance unit 311 accepts the target paint information input operation, generates operation information according to the operation, and notifies the paint information notification unit 312 of the operation information.

When the operation information corresponding to the target paint information input operation is notified from the acceptance unit 311, the paint information notification unit 312 generates target paint information including paint information indicating each of the two types of paints and used layer identification information for identifying a layer in which a corresponding one of the two types of paints is to be used, and transmits the target paint information to the cloud server 1.

When acquiring the paint-related information transmitted from the cloud server 1, the paint-related information acquisition unit 313 extracts the overcoating possibility information indicating the overcoating possibility to be described later and thinner information indicating each thinner that can be used for a respective one of the two types of paints, which are included in the acquired paint-related information, and notifies the display control unit 314 of the extracted overcoating possibility information and thinner information.

The display control unit 314 forms a paint-related information notification image including information regarding whether overcoating can be performed and information indicating the name of the thinner applicable to the two types of paints designated by the user based on the overcoating possibility information and the thinner information notified from the paint-related information acquisition unit 313, and causes the display unit 304 to display the paint-related information notification image.

As illustrated in FIG. 2, the cloud server 1 includes a CPU 101, a main storage unit 102, an auxiliary storage unit 103, a communication unit 106, and a bus 109 that connects these units to each other, and it functions as a coating material-related information providing device that provides information related to a coating material including a paint to a coating contractor. The CPU 101 is, for example, a multi-core processor. The main storage unit 102 includes a volatile memory and is used as a work area of the CPU 101. The auxiliary storage unit 103 includes a large-capacity nonvolatile memory and stores a program for implementing various functions of the cloud server 1. The communication unit 106 is connected to the network NW1.

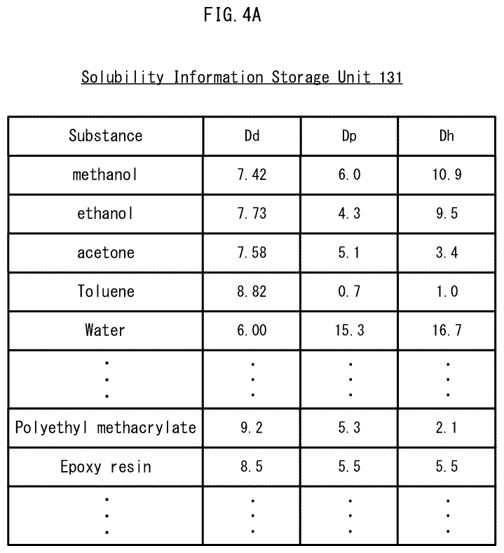

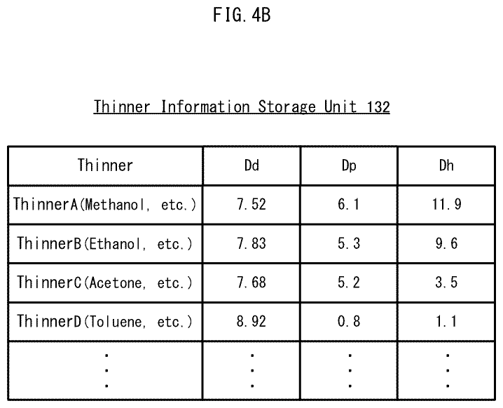

The CPU 101 reads the program stored in the auxiliary storage unit 103 into the main storage unit 102 and executes the program, thereby functioning as a paint information acquisition unit 111, a solubility parameter calculation unit 112, a thinner specifying unit 113, an overcoating possibility determination unit 114, and a paint-related information notification unit 115 as illustrated in FIG. 3. As illustrated in FIG. 3, the auxiliary storage unit 103 illustrated in FIG. 2 includes a solubility information storage unit 131, a thinner information storage unit 132, a paint information storage unit 133, and a determination reference storage unit 134. For example, as illustrated in FIG. 4A, the solubility information storage unit 131 stores solubility parameter information indicating a solubility parameter of each of a plurality of types of substances set in advance in association with substance information indicating the corresponding substance. Examples of the plurality of types of substances include organic substances, water, pigments, and resin curing agents contained in a paint. Here, the solubility parameter is a thermodynamic parameter proposed by J. H. Hildebrand in 1950. The solubility parameter is defined for a plurality of types of substances, and is an index used to predict the solubility of each substance in another substance. The solubility parameter proposed by C. M. Hansen is expressed by a three-dimensional parameter including a dispersing power component reflecting energy due to an intermolecular dispersing power, a polar component reflecting energy due to an intermolecular dipole interaction, and a hydrogen bond component reflecting energy due to an intermolecular hydrogen bond, which is the HANSEN solubility parameter (hereinafter, the parameter is appropriately referred to as “HSP value”). At present, the HSP value is widely used for evaluation of compatibility between a polymer and a solvent, between polymers, and the like, selection of an optimum solvent, selection of an optimum combination of mixed solvents, and the like in production processes of paints, thinners, and the like. In FIG. 4A, Dd represents a dispersing force component, Dp represents a polar component, and Dh represents a hydrogen bonding component. In the example illustrated in FIG. 4A, solubility parameters of organic solvents such as methanol and ethanol, and solubility parameters of resins such as polyethyl methacrylate and epoxy resin are stored.

For example, as illustrated in FIG. 4B, the thinner information storage unit 132 stores the solubility parameter of each of a plurality of types of thinners in advance in association with the thinner information indicating the corresponding thinner. In the example illustrated in FIG. 4B, solubility parameter information such as “thinner A” containing methanol and the like, “thinner B” containing ethanol and the like is stored.

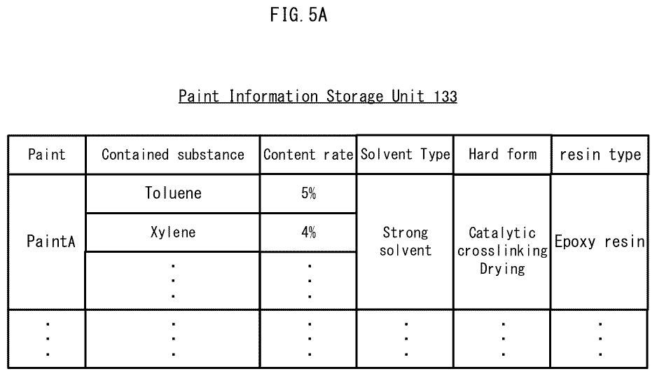

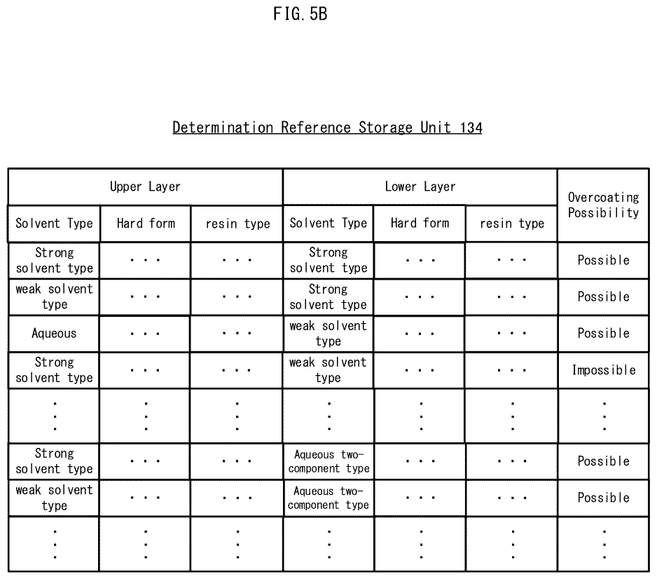

For example, as illustrated in FIG. 5A, the paint information storage unit 133 stores contained substance information indicating each contained substance contained in a respective one of a plurality of types of paints set in advance, content rate information indicating a content rate of each contained substance, solvent classification information indicating the classification of solvent used in the paint, hard form information indicating the hard form of the paint, and resin type information indicating the type of resin in association with the paint information indicating the corresponding paint. The “hard form” refers to a method for drying and curing a paint, and examples thereof include “Catalyst crosslinking drying”, “Volatilization drying”, “Oxidation polymerization drying”, “Two-component crosslinking drying”, “Thermal crosslinking drying”, “Photocrosslinking”, and “Electron beam crosslinking”. Examples of the “Type of resin” include “Phenol resin”, “Alkyd resin”, “Melamine urea resin”, “Epoxy resin”, “Polyurethane resin”, “Silicone resin”, “Rubber chloride type”, “Vinyl acetate resin”, “Acrylic resin”, “Vinyl chloride resin”, “Fluororesin”, “Cellulose”, and “Polyester resin”. The example illustrated in FIG. 5A indicates that “Paint A” contains 5% of “Toluene” and 4% of “Xylene”, and the classification of solvent used is “Strong solvent type”. The classification of the solvent may be determined based on, for example, the solubility parameter described later.

Return to FIG. 3. The determination reference storage unit 134 stores reference distance information indicating a reference distance with respect to a distance between a coordinate corresponding to the paint and a coordinate corresponding to the thinner in a three-dimensional space of the solubility parameter used to specify the thinner described later. As the “thinner” used herein, for example, a thinner dedicated to the paint recommended by the paint manufacturer can be adopted. In addition, for example, as illustrated in FIG. 5B, the determination reference storage unit 134 stores the overcoating possibility information indicating the possibility of overcoating corresponding to each combination of the classification of solvent of the paint used for the upper layer, the hard form of the paint, the type of resin and the classification of solvent of the lower layer, the hard form of the paint, and the type of resin when the two types of paints are overcoated, in association with the solvent classification information indicating the classification of the corresponding solvent, the hard form information indicating the hard form of the paint, and the resin type information indicating the type of resin. The solvent classification information includes information indicating the classification of solvent such as a strong solvent type which is a solvent having a high proportion of molecules having strong solubility, a weak solvent type which is a solvent having a high proportion of molecules having relatively weak solubility, and aqueous solvent having a high proportion of moisture contained with weak solubility. In the example illustrated in FIG. 5B, when the hard forms of the paints and the types of the resins are the same, and at the same time the classification of the solvent of the paint used for the upper layer and the classification of the solvent of the paint used for the lower layer are both in a strong solvent type, it is indicated that “Overcoating is possible”. The overcoating possibility information stored in the determination reference storage unit 134 is set to be “Overcoating is possible” when the classifications of the solvents contained in the paint of the lower layer and the paint of the upper layer are the same, “overcoating is possible” when the classification of the solvent contained in the paint of the lower layer is “Strong solvent type” and the classification of the solvent contained in the paint of the upper layer is “Weak solvent type” or “Aqueous”, and “overcoating is possible” when the classification of the solvent contained in the paint of the lower layer is “Weak solvent type” and the classification of the solvent contained in the paint of the upper layer is “Aqueous”. On the other hand, the overcoating possibility information stored in the determination reference storage unit 134 is set to be “Overcoating is impossible” when the classification of the solvent contained in the paint of the lower layer is “Weak solvent type” and the classification of the solvent contained in the paint of the upper layer is “Strong solvent type”, and “Overcoating is impossible” when the classification of the solvent contained in the paint of the lower layer is “Aqueous” and the classification of the solvent contained in the paint of the upper layer is “Weak solvent type” or “Strong solvent type”. Further, the overcoating possibility information stored in the determination reference storage unit 134 is set to be “Overcoating is possible” when the classification of the solvent contained in the paint of the lower layer is “Aqueous two-component type” and the classification of the solvent contained in the paint of the upper layer is “Weak solvent type” or “Strong solvent type”. As the classification of the solvent, for “Strong solvent type”, “Strong solvent type”: one-component type (moisture effect type), two-component type (reaction curing type), and the like, and for “Weak solvent type”, “one-component type”, “two-component type”, and “Aqueous”, which are subdivided into “one-component type”, “two-component type”, and the like may be adopted.

Return to FIG. 3. When acquiring the target paint information transmitted from the terminal device 3, the paint information acquisition unit 111 extracts paint information indicating each of the two types of paints included in the acquired target paint information and used layer identification information corresponding to each of the two types of paints. Then, the paint information acquisition unit 111 notifies the solubility parameter calculation unit 112 and the overcoating possibility determination unit 114 of the extracted paint information, and notifies the overcoating possibility determination unit 114 of the extracted used layer identification information.

When the paint information is notified from the paint information acquisition unit 111, the solubility parameter calculation unit 112 specifies the contained substance information corresponding to the notified paint information and the content rate information corresponding thereto from the contained substance information stored in the paint information storage unit 133 and the content rate information corresponding thereto. In addition, the solubility parameter calculation unit 112 specifies solubility parameter information corresponding to the contained substance indicated by the specified contained substance information from among the solubility parameter information stored in the solubility information storage unit 131. Then, the solubility parameter calculation unit 112 calculates the solubility parameter based on the specified contained substance information and the content rate of each of at least one type of contained substance indicated by the content rate information, and the solubility parameter indicated by the specified solubility parameter information. Here, for example, when the Hansen solubility parameter (HSP) value is adopted as the solubility parameter, the solubility parameter calculation unit 112 calculates the solubility parameters Dd, Dp, and Dh using the relational expressions of the following Expressions (1) to (3).
Mathematical Formula 1
   Expression (1)
Mathematical Formula 2
   Expression (2)
Mathematical Formula 3
   Expression (3)

Here, i (positive integer) represents an index for identifying each contained substance contained in the paint, and I represents the number of types of contained substances. φ[i] represents the volume fraction of each contained substance in the paint. D[i]d indicates a solubility parameter indicating a dispersing power component of the contained substance identified by the index “i”, D[i]p indicates a solubility parameter indicating a polar component of the contained substance identified by the index “i”, and D[i]h indicates a solubility parameter indicating a hydrogen bond component of the contained substance identified by the index “i”. Then, the solubility parameter calculation unit 112 notifies the thinner specifying unit 113 of solubility parameter information indicating the calculated solubility parameter.

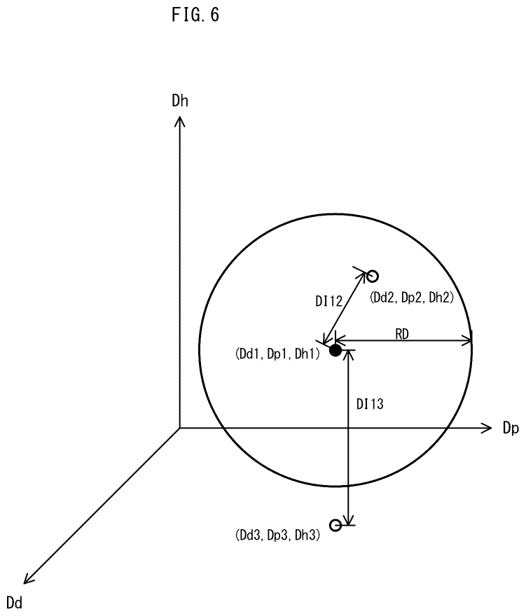

When the solubility parameter information is notified from the solubility parameter calculation unit 112, the thinner specifying unit 113 specifies the thinner having the solubility parameter corresponding to the coordinates whose distance from the coordinates corresponding to the solubility parameter of each of the two types of paints designated by the user indicated by the solubility parameter information is equal to or less than the reference distance indicated by the reference distance information stored in the determination reference storage unit 134 in the three-dimensional space representing the solubility parameter. Here, the thinner specifying unit 113 calculates the distance between the coordinates corresponding to each of a plurality of types of preset thinners stored in the thinner information storage unit 132 and the coordinates corresponding to the solubility parameter indicated by the notified solubility parameter information, and specifies a thinner whose calculated distance is equal to or less than the above-described reference distance. Here, for example, as illustrated in FIG. 6, when the coordinates corresponding to the paint designated by the user are (Dd1, Dp1, Dh1) and the distance DI12 to the thinner corresponding to the coordinates (Dd2, Dp2, Dh2) is shorter than the reference distance RD, the thinner specifying unit 113 specifies the thinner. When the distance DI13 to the thinner corresponding to the coordinates (Dd3, Dp3, Dh3) is longer than the reference distance RD, the thinner specifying unit 113 does not specify the thinner. Return to FIG. 3. The thinner specifying unit 113 notifies the paint-related information notification unit 115 of thinner information indicating the specified thinner.

When the paint information and the used layer identification information are notified from the paint information acquisition unit 111, the overcoating possibility determination unit 114 refers to the solvent classification information stored in the paint information storage unit 133 and specifies the solvent classification information corresponding to the notified paint information. In addition, the overcoating possibility determination unit 114 specifies a combination of the solvent classification of the upper layer and the solvent classification of the lower layer for the two types of paints to be overcoated based on the specified solvent classification information and used layer identification information. The overcoating possibility determination unit 114 refers to the overcoating possibility information stored in the determination reference storage unit 134 to specify the overcoating possibility information corresponding to the specified combination of the solvent classifications of the upper layer and the lower layer. The overcoating possibility determination unit 114 notifies the paint-related information notification unit 115 of the identified overcoating possibility information.

The paint-related information notification unit 115 generates paint-related information including the thinner information notified from the thinner specifying unit 113 and the overcoating possibility information notified from the overcoating possibility determination unit 114, and transmits the paint-related information to the terminal device 3.

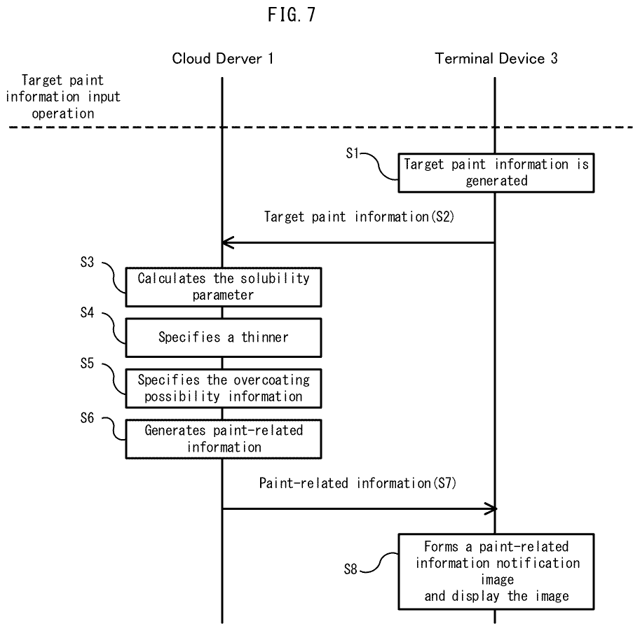

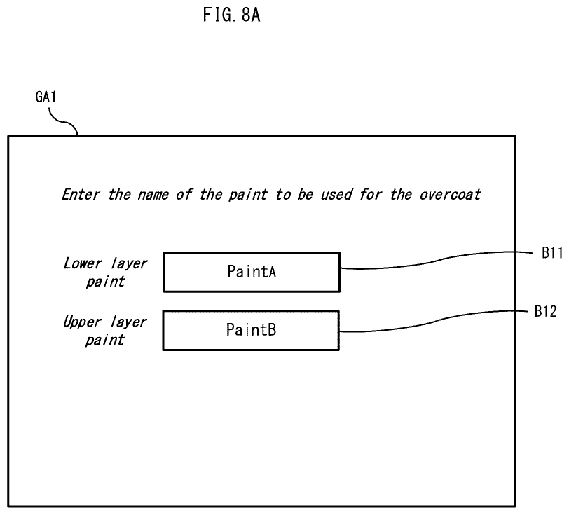

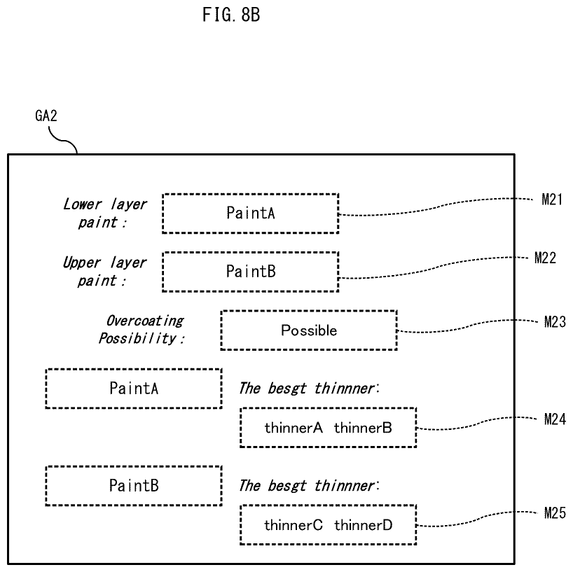

Next, the operation of the paint-related information providing system according to the present embodiment will be described with reference to FIGS. 7 and 8. First, as illustrated in FIG. 7, when the coating contractor performs the above-described target paint information input operation on the input unit 305 of the terminal device 3, the target paint information input operation is accepted, and target paint information including paint information indicating each of two types of paints to be overcoated designated by the user and used layer identification information for identifying a layer to use each of the two types of painting is generated (step S1). Here, the terminal device 3 forms an overcoating determination target paint input screen image GA1 including input fields B11 and B12 for inputting the paint names of two types of paints to be overcoated as illustrated in FIG. 8A, for example, and displays the overcoating determination target paint input screen image GA1 on the display unit 304. Then, in the target paint information input operation, the user performs an operation of inputting a paint name to each of the input fields B11 and B12 via the input unit 305. Return to FIG. 7. Next, the generated target paint information is transmitted from the terminal device 3 to the cloud server 1 (step S2).

On the other hand, when acquiring the target paint information transmitted from the terminal device 3, the cloud server 1 extracts paint information indicating each of the two types of paints included in the acquired target paint information and used layer identification information corresponding to each of the two types of paints. Then, the cloud server 1 specifies the contained substance information corresponding to the extracted paint information and the content rate information corresponding thereto from the contained substance information stored in the paint information storage unit 133 and the content rate information corresponding thereto. In addition, the cloud server 1 specifies solubility parameter information corresponding to the contained substance indicated by the specified contained substance information from among the solubility parameter information stored in the solubility information storage unit 131. Then, the cloud server 1 calculates the solubility parameter based on the content rate of each of at least one type of contained substance indicated by the specified contained substance information and the content rate information and the solubility parameter indicated by the specified solubility parameter information (step S3).

Subsequently, the cloud server 1 specifies a thinner having a solubility parameter corresponding to the coordinates whose distance from the coordinates corresponding to the calculated solubility parameter is equal to or less than the reference distance in the three-dimensional space representing the solubility parameter (step S4). Thereafter, the cloud server 1 refers to the solvent classification information stored in the paint information storage unit 133 to specify the solvent classification information corresponding to the extracted paint information, and specifies a combination of the upper and lower solvent classifications for the two types of paints to be overcoated based on the specified solvent classification information and the extracted used layer identification information. The cloud server 1 then refers to the overcoating possibility information stored in the determination reference storage unit 134 to specify the overcoating possibility information corresponding to the specified combination of the solvent classifications of the upper layer and the lower layer (step S5).

Next, the cloud server 1 generates paint-related information including thinner information indicating the specified thinner and the specified overcoating possibility information (step S6), and the generated paint-related information is transmitted from the cloud server 1 to the terminal device 3 (step S7).

On the other hand, when acquiring the paint-related information transmitted from the cloud server 1, the terminal device 3 extracts the overcoating possibility information indicating the overcoating possibility to be described later and the thinner information indicating the thinner that can be used for each of the two types of paints, which are included in the acquired paint-related information. Then, the terminal device 3 forms a paint-related information notification image including information regarding whether overcoating can be performed and information indicating the name of the thinner applicable to the two types of paints designated by the user based on the extracted overcoating possibility information and thinner information, and displays the paint-related information notification image on the display unit 304 (step S8). Here, the terminal device 3 causes the display unit 304 to display a paint-related information notification image GA2 as illustrated in FIG. 8B, for example. Here, the paint-related information notification image GA2 includes message images M21 and M22 indicating the paint names of the two types of paints to be overcoated designated by the user, a message image M23 indicating overcoating possibility, and message images M24 and M25 indicating the names of thinners that can be applied to the paints designated by the user.

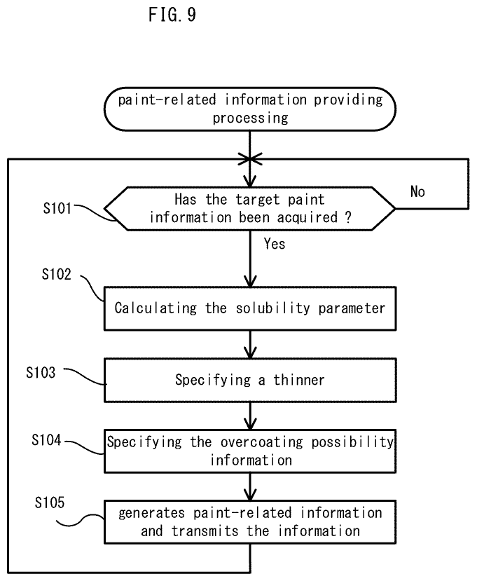

Next, paint-related information providing processing executed by the cloud server 1 according to the present embodiment will be described with reference to FIG. 9. The paint-related information providing processing is started when a program for executing the paint-related information providing processing is activated in the cloud server 1. First, the paint information acquisition unit 111 determines whether the target paint information transmitted from the terminal device 3 has been acquired (step S101). Here, as long as the paint information acquisition unit 111 determines that the target paint information has not been acquired (step S101: No), the processing of step S101 is repeatedly executed. On the other hand, when determining that the target paint information has been acquired (step S101: Yes), the paint information acquisition unit 111 extracts paint information indicating each of the two types of paints included in the acquired target paint information and used layer identification information corresponding to each of the two types of paints. Then, the paint information acquisition unit 111 notifies the solubility parameter calculation unit 112 and the overcoating possibility determination unit 114 of the extracted paint information, and notifies the overcoating possibility determination unit 114 of the extracted used layer identification information.

Next, the solubility parameter calculation unit 112 specifies the contained substance information corresponding to the notified paint information and the content rate information corresponding thereto from the contained substance information stored in the paint information storage unit 133 and the content rate information corresponding thereto. In addition, the solubility parameter calculation unit 112 specifies solubility parameter information corresponding to the contained substance indicated by the specified contained substance information from among the solubility parameter information stored in the solubility information storage unit 131. Then, the solubility parameter calculation unit 112 calculates the solubility parameter based on the content rate of each of at least one type of contained substance indicated by the specified contained substance information and the content rate information and the solubility parameter indicated by the specified solubility parameter information (step S102).

Subsequently, when the solubility parameter information is notified from the solubility parameter calculation unit 112, the thinner specifying unit 113 specifies the thinner having the solubility parameter corresponding to the coordinates whose distance from the coordinates corresponding to the solubility parameter of each of the two types of paints designated by the user indicated by the solubility parameter information is equal to or less than the reference distance indicated by the reference distance information stored in the determination reference storage unit 134 in the three-dimensional space indicating the solubility parameter (step S103). Here, the thinner specifying unit 113 notifies the paint-related information notification unit 115 of thinner information indicating the specified thinner.

Thereafter, when the paint information and the used layer identification information are notified from the paint information acquisition unit 111, the overcoating possibility determination unit 114 refers to the solvent classification information stored in the paint information storage unit 133 and specifies the solvent classification information corresponding to the notified paint information. In addition, the overcoating possibility determination unit 114 specifies a combination of the solvent classification of the upper layer and the solvent classification of the lower layer for the two types of paints to be overcoated based on the specified solvent classification information and used layer identification information. Then, the overcoating possibility determination unit 114 refers to the overcoating possibility information stored in the determination reference storage unit 134 and specifies the overcoating possibility information corresponding to the specified combination of the solvent classifications of the upper layer and the lower layer (step S104). Here, the overcoating possibility determination unit 114 notifies the paint-related information notification unit 115 of the specified overcoating possibility information.

Next, the paint-related information notification unit 115 generates paint-related information including the thinner information notified from the thinner specifying unit 113 and the overcoating possibility information notified from the overcoating possibility determination unit 114, and transmits the paint-related information to the terminal device 3 (step S105). Subsequently, the processing in step S101 is executed again.

As described above, according to the cloud server 1 of the present embodiment, the overcoating determination unit 114 determines whether it is possible to overcoat the two types of paints based on at least one of the hard form of each paint and the type of each resin contained in a respective one of the two types of paints designated by the user to be overcoated. In addition, the thinner specifying unit 113 specifies a thinner that can be mixed with the two types of paints designated by the user based on the solubility parameter of each of these paints. Then, the paint-related information notification unit 115 generates paint-related information including the overcoating possibility information indicating the possibility of overcoating and thinner information indicating the specified thinner, and transmits the paint-related information to the terminal device 3. It makes it possible to appropriately present, to the user, information on the affinity between two types of paints when the two types of paints are applied in an overlapping manner or when a thinner is mixed with the paints via the paint-related information including the overcoating possibility information and the thinner information transmitted to the terminal device 3.

Meanwhile, in the case of using a paint, a coating contractor usually dilutes the paint by using a thinner designated by the manufacturer of the paint, but when the thinner designated by the manufacturer is not at hand, it is required to efficiently use the coating material by substituting a thinner not designated by the manufacturer. For this, the cloud server 1 according to the present embodiment selects a thinner that can be substituted for the thinner designated by the manufacturer based on the solubility parameter of the substance contained in the paint and the solubility parameter of the thinner, and transmits paint-related information including the thinner information to the terminal device 3. As a result, the coating contractor can effectively utilize the thinner in stock by referring to the thinner information included in the paint-related information displayed on the display unit 304 of the terminal device 3, and thus, it is possible to reduce the stock owned by the coating contractor and promote the reuse of the thinner.

### Second Embodiment

The present embodiment is different from the first embodiment in that the cloud server has only a function of specifying a thinner that can be mixed with a paint designated by the user. That is, in the present embodiment, the cloud server determines whether the paint designated by the user and the thinner to be mixed with the paint can be mixed.

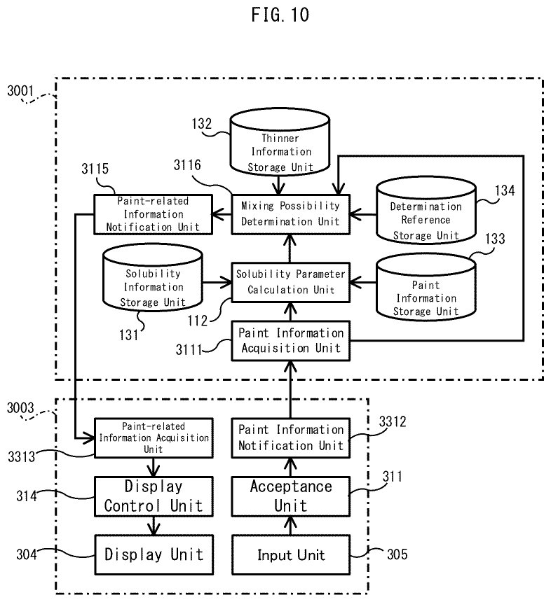

For example, as illustrated in FIG. 10, a terminal device 3003 according to the present embodiment includes an acceptance unit 311, a paint information notification unit 3312, a paint-related information acquisition unit 3313, and a display control unit 314. In FIG. 10, the same components as those in the first embodiment are denoted by the same reference numerals as those in FIG. 3. Here, when the coating contractor performs target paint information input operation to input the paint name of the paint to be mixed and the name of the thinner to the input unit 305, the acceptance unit 311 accepts the target paint information input operation, generates operation information corresponding to the operation, and notifies the paint information notification unit 3312 of the operation information. When the operation information corresponding to the target paint information input operation is notified from the acceptance unit 311, the paint information notification unit 3312 generates target paint information including paint information indicating the paint and thinner to be mixed and thinner information, and transmits the information to the cloud server 3001.

The cloud server 3001 also includes a paint information acquisition unit 3111, a solubility parameter calculation unit 112, a mixing possibility determination unit 3116, and a paint-related information notification unit 3115. When acquiring the target paint information transmitted from the terminal device 3, the paint information acquisition unit 3111 extracts the paint information and the thinner information included in the acquired target paint information. Then, the paint information acquisition unit 3111 notifies the solubility parameter calculation unit 112 of the extracted paint information, and notifies the mixing possibility determination unit 3116 of the extracted thinner information.

When the thinner information is notified from the paint information acquisition unit 3111, the mixing possibility determination unit 3116 specifies the coordinates corresponding to the thinner indicated by the notified thinner information from among the coordinates corresponding to each of a plurality of preset types of thinners stored in the thinner information storage unit 132. Then, the mixing possibility determination unit 3116 determines whether the distance between the coordinates corresponding to the solubility parameter of the paint indicated by the solubility parameter information notified from the solubility parameter calculation unit 112 and the coordinates corresponding to the specified thinner in the three-dimensional space representing the solubility parameter is equal to or less than the reference distance indicated by the reference distance information stored in the determination reference storage unit 134. Then, the mixing possibility determination unit 3116 notifies the paint-related information notification unit 3115 of determination result information indicating the determination result. The paint-related information notification unit 3115 generates paint-related information including the determination result information notified from the mixing possibility determination unit 3116, and transmits the paint-related information to the terminal device 3003.

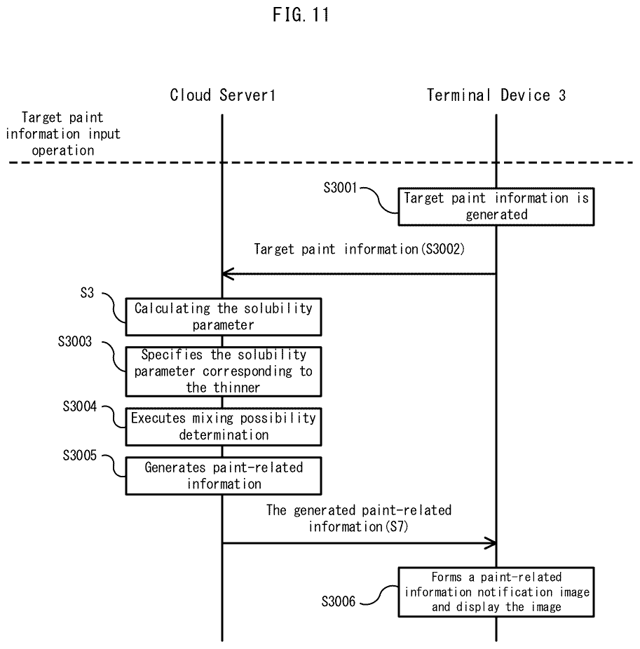

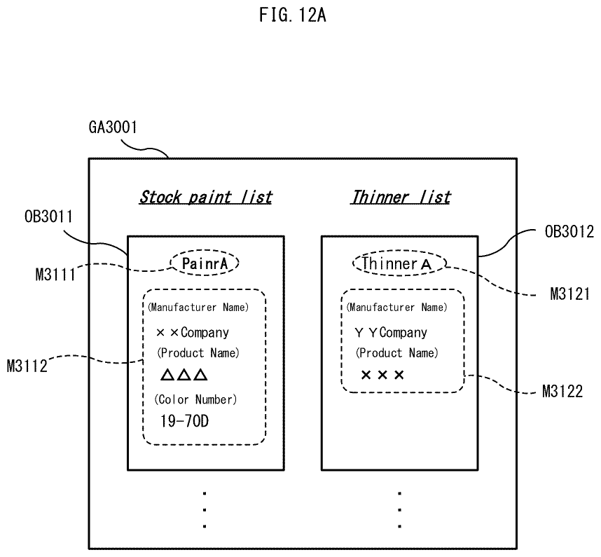

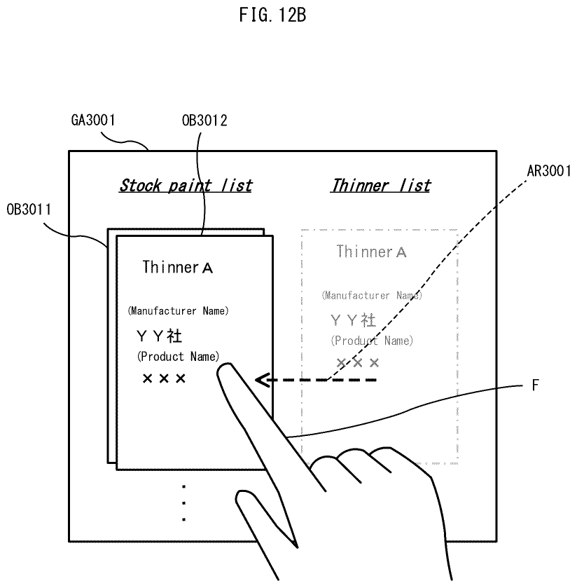

Next, processing executed by the paint-related information providing system according to the present embodiment will be described with reference to FIGS. 11 to 13. In FIG. 11, processing similar to those in the first embodiment are denoted by the same reference numerals as those in FIG. 7. First, as illustrated in FIG. 11, when the coating contractor performs the above-described target paint information input operation on the input unit 305 of the terminal device 3, the target paint information input operation is accepted, and target paint information including paint information indicating the paint and thinner to be mixed designated by the user and thinner information is generated (step S3001). Here, the terminal device 3 forms a mixing determination target input screen image GA3001 including an object image OB3011 showing each of a plurality of paints and an object image OB3012 showing each of a plurality of thinners as illustrated in FIG. 12A, for example, and displays the image on the display unit 304. The object image OB3011 includes a message image M3111 indicating the name of the paint and a message image M3112 indicating the specification of the paint, and the object image OB3012 includes a message image M3121 indicating the name of the thinner and a message image M3122 indicating the specification of the thinner. Then, in the target paint information input operation, the user selects the object images OB3001 or OB3002 corresponding to one of the paint and the thinner to be mixed via the input unit 305, and performs an operation of dragging the selected one with a finger F to overlap the selected one to the other as shown by an arrow AR3001 in FIG. 12B, for example, to designate the paint and the thinner to be mixed. Return to FIG. 11. Next, the generated target paint information is transmitted from the terminal device 3003 to the cloud server 3001 (step S3002).

On the other hand, when acquiring the target paint information transmitted from the terminal device 3003, the cloud server 3001 extracts paint information and thinner information included in the acquired target paint information. Then, the cloud server 3001 calculates the solubility parameter based on the content rate of each of at least one type of contained substance indicated by the content information and the content rate information corresponding to the extracted paint information and the solubility parameter indicated by the specified solubility parameter information (step S3).

Subsequently, the cloud server 3001 specifies the solubility parameter corresponding to the thinner indicated by the extracted thinner information from among the coordinates corresponding to each of the plurality of types of thinners in advance stored in the thinner information storage unit 132 (step S3003). Then, the cloud server 3001 executes mixing possibility determination to determine whether the distance between the coordinates corresponding to the calculated solubility parameter and the coordinates corresponding to the specified thinner in the three-dimensional space representing the solubility parameter is equal to or less than the reference distance (step S3004). Thereafter, the cloud server 3001 generates paint-related information including the determination result information indicating the determination result (step S3005), and the generated paint-related information is transmitted from the cloud server 3001 to the terminal device 3003 (step S7).

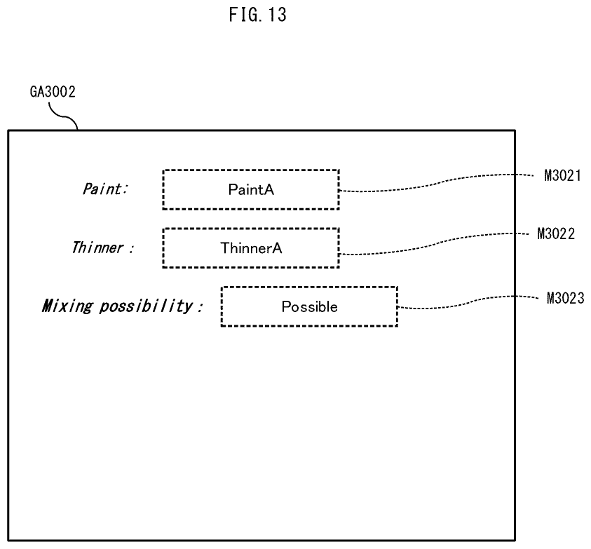

On the other hand, when acquiring the paint-related information transmitted from the cloud server 3001, the terminal device 3003 extracts the determination result information included in the acquired paint-related information. Then, the terminal device 3003 forms a paint-related information notification image including information indicating whether the paint and the thinner designated by the user can be mixed with each other based on the extracted determination result information and displays the paint-related information notification image on the display unit 304 (step S3006). Here, the terminal device 3003 causes the display unit 304 to display a paint-related information notification image GA3002 as illustrated in FIG. 13, for example. Here, the paint-related information notification image GA3002 includes message images M3021 and M3022 indicating the paint name of the paint and the name of the thinner designated by the user, and a message image M3023 indicating whether mixing is possible.

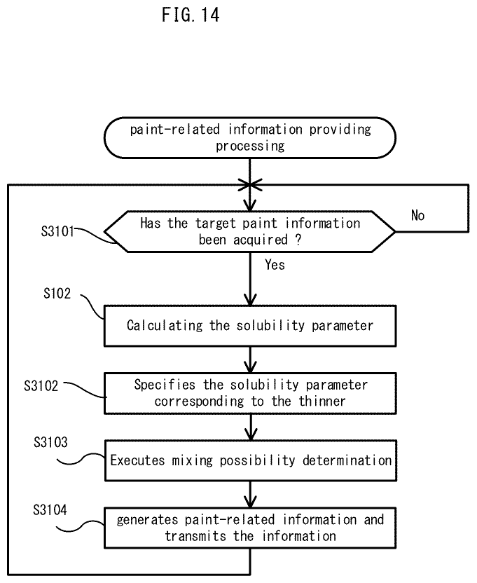

Next, paint-related information providing processing executed by the cloud server 3001 according to the present embodiment will be described with reference to FIG. 14. In FIG. 14, processing similar to those in the first embodiment are denoted by the same reference numerals as those in FIG. 9. First, the paint information acquisition unit 3111 determines whether the target paint information transmitted from the terminal device 3 has been acquired (step S3101). When determining that the target paint information has been acquired (step S3101: Yes), the paint information acquisition unit 3111 extracts paint information and thinner information included in the acquired target paint information. Then, the paint information acquisition unit 3111 notifies the solubility parameter calculation unit 112 of the extracted paint information, and notifies the mixing possibility determination unit 3116 of the extracted thinner information.

Next, after the processing of step S102 is executed, the mixing possibility determination unit 3116 specifies the solubility parameter corresponding to the thinner indicated by the notified thinner information from among the coordinates corresponding to each of the plurality of types of thinners in advance stored in the thinner information storage unit 132 (step S3102). Then, the mixing possibility determination unit 3116 executes mixing possibility determination to determine whether the distance between the coordinates corresponding to the solubility parameter of the paint indicated by the solubility parameter information notified from the solubility parameter calculation unit 112 and the coordinates corresponding to the specified solubility parameter of the thinner is equal to or less than the reference distance indicated by the reference distance information stored in the determination reference storage unit 134 in the three-dimensional space representing the solubility parameter (step 3103).

Thereafter, the paint-related information notification unit 3115 generates paint-related information including the determination result information notified from the mixing possibility determination unit 3116, and transmits the paint-related information to the terminal device 3003 (step S3104). Subsequently, the processing in step S3101 is executed again.

As described above, according to the present embodiment, it is possible to quickly grasp whether the paint and the thinner designated by the user can be mixed with each other, and thus, it is possible to improve convenience for the user.

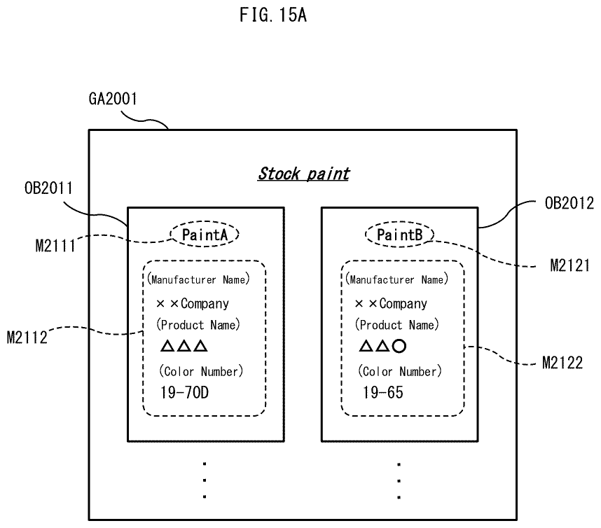

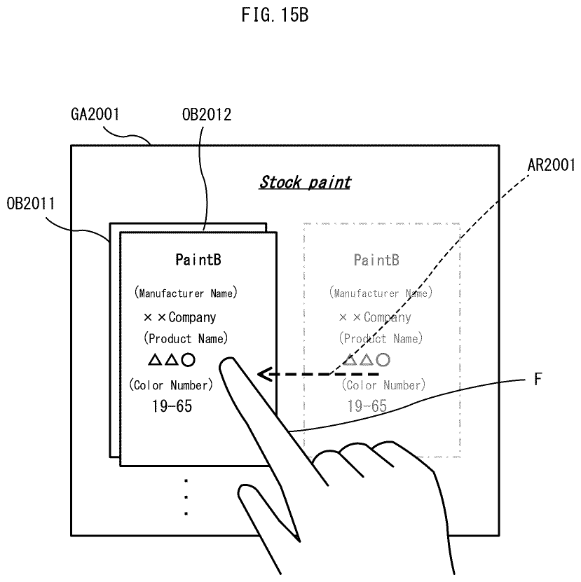

Although the embodiments of the present invention have been described above, the present invention is not limited to the above-described embodiments. For example, in the first embodiment, the terminal device 3 may form an overcoating determination target paint input screen image GA2001 including object images OB2011 and OB2012 indicating a plurality of paints, for example, as illustrated in FIG. 15A, and cause the display unit 304 to display the overcoating determination target paint input screen image. The object images OB2011 and 2012 include message images M2111 and 2121 indicating the names of the paints and message images M2112 and 2122 indicating the specifications of the paints. Then, in the target paint information input operation, the user selects the object image OB2012 corresponding to the upper layer paint between the two types of paints to be overcoated via the input unit 305, and performs an operation of dragging with the finger F to overlap the object image OB2012 on the object image OB2011 corresponding to the lower layer paint as indicated by an arrow AR2001 in FIG. 15B, for example, to designate the upper layer and the lower layer paints to be overcoated.

According to this configuration, it is easy for the user to visually grasp the upper layer and the lower layer of the two types of paints to be overcoated, and thus, the convenience of the user can be enhanced. For example, when the user overcoats a plurality of types of paints owned by the user, there is an advantage that compatibility between the paints to be overcoated can be easily confirmed when there is a concern about compatibility between the paints.

In the first embodiment, for example, the terminal device 3 may form a mixing possibility determination target input screen image including an object image including object images indicating a plurality of paints or thinners, respectively, and cause the display unit 304 to display the images, and when the user selects one of the plurality of object images, the terminal device 3 may change the display mode of the object image corresponding to the paint, the paint that can be mixed with the thinner, or the thinner corresponding to the selected object image according to the mixing possibility. For example, in the initial state, the color inside a rectangular frame line image is displayed in white, and when one object image is selected by the user, the color inside the object image may be changed to another color (for example, green), and the color of the object image corresponding to the paint or thinner that can be mixed with the paint or thinner corresponding to the object image may be changed to a different color according to the mixing possibility. For example, the color of the inside may be displayed in light blue when mixing is possible, the color of the inside may be displayed in light red when mixing is impossible, and the color of the inside may be displayed in light yellow when it is unknown.

In the first embodiment, an example has been described in which the cloud server 1 specifies each thinner that can be mixed with a respective one of the two types of paints designated by the user, but the present invention is not limited to this example. For example, the cloud server may specify a paint that can be mixed with the thinner designated by the user.

In the first embodiment, an example has been described in which the cloud server 1 determines whether two types of paints designated by the user can be overcoated. The present invention is not limited to this example. For example, when the cloud server designates one type of paint of the upper layer or the lower layer when the user overcoats two types of paints, a paint that can be overcoated on the designated lower layer paint or a paint that can be adopted as the lower layer paint with respect to the designated upper layer paint may be specified with reference to the paint information stored in the paint information storage unit 133 and the determination reference information stored in the determination reference storage unit 134.

In the first embodiment, the thinner specifying unit 113 specifies the thinner recommended by the manufacturer of the paint for the paint selected by the user, and specifies the solubility parameter of the specified thinner from the information of the solubility parameter stored in the thinner information storage unit 132. Then, the thinner specifying unit 113 may specify the thinner information of the thinner in which a difference from the solubility parameter of the thinner recommended by the specified manufacturer falls within a preset reference range from the thinner information stored in the thinner information storage unit 132. Here, the reference range can be set, for example, within ±5% of the solubility parameter recommended by the manufacturer.

Alternatively, the thinner specifying unit 113 may select one rank from a plurality of ranks set in advance for appropriateness of adoption as a thinner based on the type of solvent contained in the thinner recommended by the paint manufacturer and the contents of various solvents. For example, when the thinner as a selection candidate is the same as the thinner recommended by the paint manufacturer, the thinner may be selected as rank A. When the content rate of the same type of solvent as the solvent most contained in the thinner recommended by the paint manufacturer is different from the content rate of the solvent contained in the thinner recommended by the paint manufacturer by ±20% or less, the thinner as a selection candidate may be selected as rank B. When the content rate of the same type of solvent as the solvent most contained in the thinner recommended by the paint manufacturer is different from the content rate of the solvent contained in the thinner recommended by the paint manufacturer by more than ±20%, the thinner as a selection candidate may be selected as rank C. Alternatively, when the solvent having the highest content rate and the solvent having the second highest content rate match each other between the thinner that is a selection candidate and the thinner recommended by the paint manufacturer, and the total content rate of these solvents is 60% or more, the thinner as a selection candidate may be selected as rank A, when the solvent having the highest content rate and the solvent having the second highest content rate match each other between the thinner that is a selection candidate and the thinner recommended by the paint manufacturer, and the total content rate of these solvents is less than 60%, the thinner as a selection candidate may be selected as rank B, when the solvent having the highest content rate and the solvent having the second highest content rate are different from each other but the types thereof match each other between the thinner that is a selection candidate and the thinner recommended by the paint manufacturer, and the total content rate of these solvents is 60% or more, the thinner as a selection candidate may be selected as rank C, and when the solvent having the highest content rate and the solvent having the second highest content rate are different from each other between the thinner selected as a selection candidate and the thinner recommended by the paint manufacturer, but the types of the solvents match with each other, and the total content rate of these solvents is less than 60%, the thinner as a selection candidate may be selected as rank D. Here, the type of thinner may be classified into, for example, hydrocarbons, alcohols, acetic esters, ketones, cellosolves, glycol ethers, ethers, chlorinated hydrocarbons, nitrogen-containing substances, and the like. Alternatively, the type of thinner may be classified based on whether the thinner is a strong solvent, a weak solvent, or an aqueous solvent.

In the first embodiment, an example in which three HSP indicating the dispersing force component Dd, the polar component Dp, and the hydrogen bonding component Dh are adopted as the solubility parameters has been described, but the present invention is not limited to this example. The distance derived from the three solubility parameters of the paint and the thinner, that is, the SP value of Hildebrand may be adopted as the solubility parameter.

In the first embodiment, the cloud server 1 may further include a determination reference update unit that updates the determination reference information based on result information indicating results of the paints actually used for the upper layer and the lower layer. Alternatively, the cloud server 1 may include a coating material estimation unit that estimates at least one of the paint that can be overcoated on the paint designated by the user and the thinner that can be mixed with the paint using a coating material estimation model that outputs information indicating at least one of the paint that can be overcoated on the paint indicated by the paint information and the thinner that can be mixed with the paint when the paint information indicating the paint designated by the user is input. In this case, the cloud server 1 may include a coating material estimation model update unit that learns the coating material estimation model using the paint information included in the above-described result information, the paint indicated by the thinner information, and the solubility parameter of the thinner as teacher data.

In the first embodiment, the cloud server 1 may further include a reference distance information update unit that updates the reference distance information indicated by the reference distance information stored in the determination reference storage unit 134 based on the track record information indicating the track record of the thinner actually used.

In the embodiments, an example of determining only whether overcoating is possible has been described, but the present invention is not limited to this example. For example, the overcoating possibility determination unit may select one rank from a plurality of types of ranks set in advance for appropriateness of overcoating. Specifically, the overcoating possibility determination unit may select a rank of “Grade A” when the combination of the two types of paints is the same as the specification defined by the paint manufacturer, “Grade B” when the combination of the classification of the resin system (paint) of the upper layer paint and the classification of the resin system (paint) of the lower layer paint is appropriate, “Grade C” when the classification of paint and the classification of the resin system (paint) recognized by the paint manufacturer are the same, and “Grade D” when overcoating is impossible. Here, as the classification of resin system (paint), “two-component epoxy resin”, “one-component epoxy resin”, “one-component urethane resin”, “two-component urethane resin”, or the like may be adopted.

In the embodiments, the solubility parameter calculation unit may directly calculate the solubility parameter from the physical property value of the substance contained in the paint or the thinner. In this case, the solubility parameter calculation unit may calculate the solubility parameter by a method of obtaining the parameter from latent heat of vaporization, a method according to Hildebrand-Rule, a method with surface tension, a method of obtaining the parameter from a refractive index, or the like. Alternatively, the solubility parameter calculation unit may directly calculate the solubility parameter from the molecular structure of the substance contained in the paint or the thinner. In this case, the solubility parameter calculation unit may calculate the solubility parameter by the calculation method of Small, the calculation method of Rheineck and Lin, the calculation method of Krevelen and Hoftyzer, the calculation method of Fedors, the calculation method of Hansen, the calculation method of Hoy, the Stefanis & Panayiotou method, or the like.

In the embodiments, the solubility parameter calculation unit may calculate the solubility parameter of the paint or the thinner based on the solvent composition of the paint or the solvent composition of the thinner obtained using gas chromatography. Specifically, the solubility parameter calculation unit 112 may acquire information indicating the solvent composition of the specified paint or thinner through analysis using gas chromatography, and calculate the solubility parameter of the paint or thinner from the specified solvent solubility parameter stored in the solubility information storage unit 131 and the volume fraction of various solvents contained in the paint or thinner based on the acquired information. In the case of a paint, the paint contains a resin, a pigment, and the like, and it is difficult to extract these as a gas to be analyzed through gas chromatography. However, the resin contained in the paint is basically designed to be well soluble in a solvent in many cases. Thus, the solubility parameter calculation unit calculates the solubility parameter of the paint assuming that the value of the solubility parameter of the resin in the paint is substantially the same as the value of the solubility parameter of the solvent in the paint. That is, the solubility parameter calculation unit calculates the HSP value of the paint assuming that the HSP value of the solvent in the paint is substantially equal to the HSP value of the resin in the paint. In addition, the solubility parameter calculation unit may calculate the HSP value calculated for dedicated thinner that is designated to be used for the paint as the HSP value of the paint. Further, the solubility parameter calculation unit may calculate the solubility parameter of the paint or thinner from the solvent composition of the paint or thinner specified by analysis with a gas chromatograph and the solubility parameter of each solvent calculated by the method of obtaining the parameter from the latent heat of vaporization described above, the method by Hildebrand-Rule, the method with surface tension, the method of obtaining the parameter from the refractive index, or the like.

In the second embodiment, when a photograph of a label of a container is taken using a terminal device having an imaging function for a thinner that is not in stock possessed by the coating contractor, thinner information including the product name, the manufacturer name, and the like included in the photograph of the label may be read through an image recognition technology, a thinner corresponding to the thinner information may be specified based on the read thinner information, and whether the specified thinner and a paint possessed by the coating contractor can be mixed may be determined.

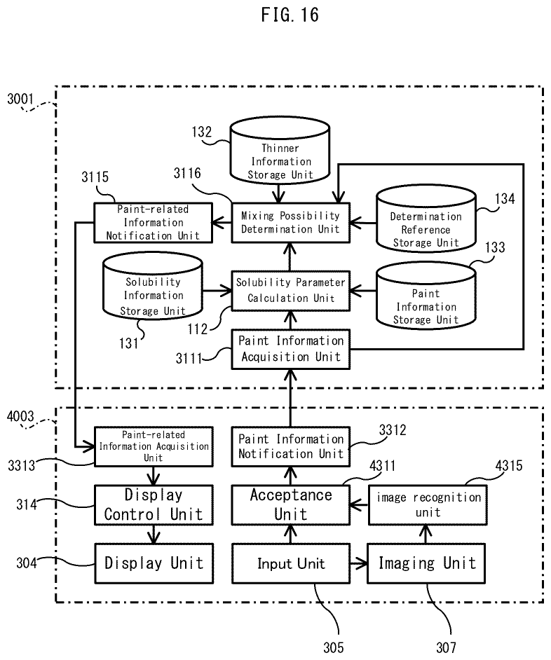

As illustrated in FIG. 16, for example, a terminal device 4003 according to the present modification includes an imaging unit 307 and an image recognition unit 4315 that executes image analysis processing using image information obtained by imaging with the imaging unit 307 and recognizes a product name, a manufacturer name, and the like included in the image information. In FIG. 16, the same components as those in the second embodiment are denoted by the same reference numerals as those in FIG. 10. The image recognition unit 4315 notifies an acceptance unit 4311 of information indicating the recognized product name, manufacturer name, and the like. Here, it is assumed that after performing a target paint information input operation of inputting the paint name of a paint possessed by the coating contractor with respect to the input unit 305, an operation of taking an image of a label of an empty container in which the thinner has been accommodated with the imaging unit 307 is performed. In this case, after accepting the target paint information input operation and generating the information indicating the paint name, when the information indicating the product name and the manufacturer name of the thinner recognized by the image recognition unit 4315 is notified, the acceptance unit 4311 generates operation information including the information indicating the paint name and the information indicating the product name and the like of the thinner and notifies the paint information notification unit 3312 of the operation information. Then, when the operation information is notified from the acceptance unit 4311, the paint information notification unit 3312 generates target paint information including paint information including information indicating the paint name possessed by the coating contractor and thinner information including the product name of the notified thinner, which are included in the operation information, and transmits the target paint information to the cloud server 3001. When the coating contractor performs an operation of taking an image of a label of an empty container in which the paint has been stored with the imaging unit 307, the image recognition unit 4315 may recognize the product name and the manufacturer name of the paint recognized through the image analysis processing and notify the acceptance unit 4311 of the recognized product name and manufacturer name. Further, the image recognition unit 4315 may recognize the product name, the manufacturer name, and the like from, for example, a taken image of the container of the thinner or paint, or an image of a two-dimensional code or a one-dimensional barcode printed on the container.

According to this configuration, the paint that can be mixed with the thinner can be specified only by taking an image of the label attached to the container of the thinner. Alternatively, the thinner that can be mixed with the paint can be specified only by taking an image of the label attached to the container of the paint. Thus, it is possible to enhance the convenience of the coating contractor.

In the second embodiment, when a photograph of a label of a container is taken using a terminal device having an imaging function for a thinner that is not in stock possessed by the coating contractor, thinner information including a product name, a manufacturer name, and the like included in the photograph of the label may be read by an image recognition technology, a thinner corresponding to the thinner information may be specified based on the read thinner information, and a thinner having a solubility parameter close to the specified thinner may be selected from the thinner possessed by the coating contractor.

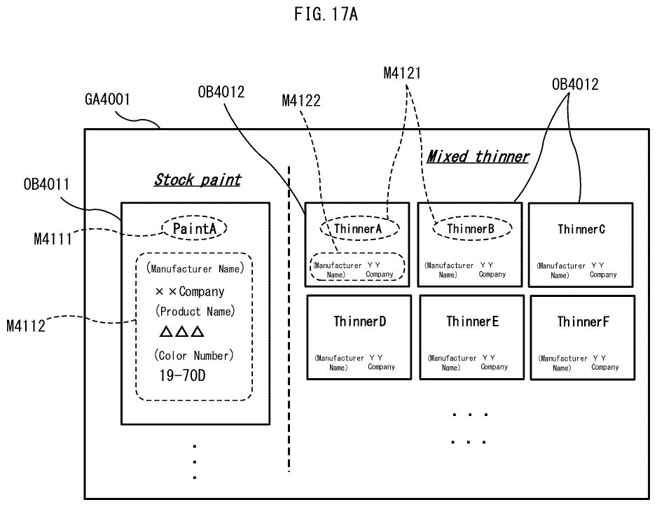

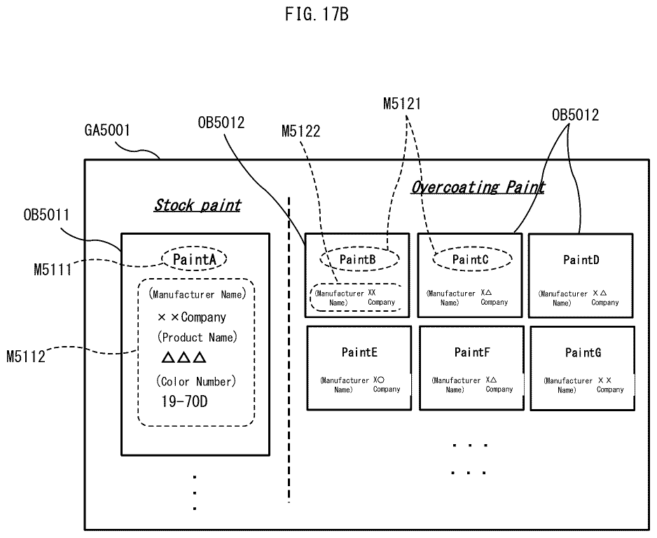

In each embodiment, the terminal device 3 may display a paint-related information notification image GA4001 on the display unit 304 as illustrated in, for example, FIG. 17A. Here, on the left side of the paint-related information notification image GA4001, an object image OB4011 of a paint owned by the coating contractor is disposed, and on the left side, an object image OB4012 of each of a plurality of thinner candidates to be mixed with the owned paint is disposed. The object image OB4011 includes a message image M4111 indicating the name of the paint and a message image M4112 indicating the specification of the paint. The object image OB4012 includes a message image M4111 indicating the name of the thinner and a message image M4112 indicating the manufacturer name of the thinner. The message image M4112 is not limited to one indicating the manufacturer name, but may indicate the distance between the coordinates represented by solubility parameters of the paint and the thinner, and a rank related to compatibility with the paint. Alternatively, the message image M4112 may include a place where the thinner is stored. Here, the object images OB4012 are arranged in order of closeness of solubility parameter, that is, in the increasing order of distance between the coordinates represented by the above-described three solubility parameters of each of the paint and the thinner, in order of match of required amount of the paint, in the decreasing order of rank regarding compatibility with the thinner to be mixed, and the like. Here, the paint search destination may be not only the own stock of the coating contractor but also an EC site where the paint is sold, a shared stock of another contractor, or the like.

In each embodiment, the terminal device 3 may have a function of displaying an inventory list image including, for example, a list of object images of paint or thinner owned by the coating contractor, and when the paint contractor performs an operation of selecting any one object image on the terminal device 3 in a state where the inventory list image is displayed on the display unit 304, the terminal device 3 displays the selected object image in a display mode in which the color of the peripheral portion or the entire color of the inside is changed. At this time, when the object image representing the paint or thinner is selected, the terminal device 3 may display the object image representing the solvent that can be mixed with the paint or thinner represented by the selected object image in a display mode in which the color of the peripheral portion or the color of the entire inner portion is changed, or may display the object image by changing the disposition of the object image in the inventory list image. When the object image representing a paint is selected, the terminal device 3 may display the object image representing a paint that can be overcoated with the paint represented by the selected object image, that is, the paint that can be used as the paint that can be topcoated or undercoated with respect to the paint, in a display mode in which the color of the peripheral portion or the color of the entire inner portion is changed, or may display the object image by changing the disposition of the object image in the inventory list image.

When the object image representing the paint or the thinner is selected, and at the same time, the solvent that can be mixed with the paint or the thinner represented by the selected object image does not exist in the inventory solvent represented by the inventory list image, the terminal device 3 may display a site image of an EC site that sells a mixable solvent or an inventory list image of a storage location different from the storage location corresponding to the inventory list image. Then, the terminal device 3 may display the object image representing the mixable solvent included in the site image or the other inventory list image in a display mode in which the color of the peripheral portion or the color of the entire inner portion is changed, or may display the object image by changing the disposition of the object image in the site image or the inventory list image. When the object image representing a paint is selected, and at the same time, a paint that can be overcoated with the paint represented by the selected object image does not exist in the inventory paint represented by the inventory list image, the terminal device 3 may display a site image of an EC site that sells an overcoatable paint or an inventory list image of a storage different from the storage corresponding to the inventory list image. Then, the terminal device 3 may display the object image representing the overcoatable paint included in the site image or the other inventory list image in a display mode in which the color of the peripheral portion or the color of the entire inner portion is changed, or may display the object image by changing the disposition of the object image in the inventory list image.

The terminal device 3 may display a paint-related information notification image GA5001 on the display unit 304 as illustrated in FIG. 17B, for example. Here, on the left side of the paint-related information notification image GA5001, an object image OB5011 of a paint owned by the coating contractor is disposed, and on the left side, an object image OB5012 of each of a plurality of paints that are candidates for overcoating with the owned paint is disposed. Here, the “overcoating” is not limited to the case of overcoating a candidate paint on a paint corresponding to the object image OB5011, but includes the case of overcoating the paint corresponding to the object image OB5011 to the candidate paint. The object image OB5011 includes a message image M5111 indicating the name of the paint and a message image M5112 indicating the specification of the paint. The object image OB5012 includes a message image M5111 indicating the name of the paint and a message image M5112 indicating the manufacturer name of the paint. The message image M5112 is not limited to one indicating the manufacturer name, but may indicate the distance between the coordinates represented by the solubility parameters of respective paints to be overcoated and a rank related to compatibility of overcoating of paint. Alternatively, the message image M5112 may include a place where the paint is stored or the like. Here, the object images OB5012 are arranged in order of closeness of solubility parameters, that is, in the increasing order of distances between the coordinates represented by the above-described three solubility parameters of the respective paints, in order of match of required amounts of the paints, in the decreasing order of rank related to compatibility of overcoating, and the like.

In the embodiments, the classification of the solvent of the paint, that is, any one of a strong solvent type, a weak solvent type, and an aqueous type may be determined based on the content of the substance contained in the paint and the solubility parameter. In this case, the solubility parameter (HSP value) of each target paint may be calculated, and the classification of the solvent may be determined based on the calculated solubility parameter. In the embodiments, the solubility parameter (HSP value) of the thinner recommended by the paint manufacturer for the paint is calculated, and the classification of the solvent of the paint corresponding to the thinner may be determined based on the calculated solubility parameter. For example, for each of a plurality of types of thinners that can be recommended for a paint, classification of strong solvent type, weak solvent type, and aqueous type may be registered based on the calculated solubility parameter, and the classification of the solvent of the paint may be determined based on the registered information at the time of obtaining the paint.

In the embodiments, the overcoating possibility determination unit may determine whether overcoating is possible based on the solubility parameter of each of the two types of paints to be overcoated. In addition, when the solubility parameter of each of the two types of paints to be overcoated is input, the overcoating possibility determination unit may estimate the overcoating possibility of the two types of paints using an overcoating possibility estimation model that outputs information indicating the overcoating possibility of the two types of paints. In this case, the cloud server 1 may include an overcoating possibility estimation model update unit that learns the overcoating possibility estimation model using the result information of the overcoating possibility of two types of paints as teacher data.

In the embodiments, a storage location storage unit (not illustrated) that stores storage location information indicating the storage location of the paint or thinner in association with the paint information or the thinner information of the paint or thinner may be further included. Then, the thinner specifying unit 113 may select a thinner that can be mixed with the paint to be determined from the thinner stored in the storage location close to the place where the paint to be determined is stored. When the thinner that can be mixed with the paint to be determined is a thinner prepared by mixing a plurality of types of thinners, the thinner may have a function of selecting a plurality of types of thinner and calculating a mixing ratio of each of the plurality of types of thinners. In this case, for example, the range of the solubility parameter of the thinner that can be mixed with the paint to be determined is specified, and the mixing ratio of each of the plurality of types of thinners that falls within the range of the specified solubility parameter may be calculated based on the predetermined solubility parameter of each of the plurality of types of thinners. Then, based on the calculated mixing ratio, the required amount of each of the plurality of types of thinners may be calculated, and the required amount of each of the plurality of types of thinners may be recommended to the coating contractor together with thinner information of each of the plurality of types of thinners that can be mixed with the paint to be determined.

The first embodiment may further include a determination reference update unit that updates, based on track record information indicating the track record of overcoating, overcoating possibility information indicating whether overcoating is possible corresponding to each combination of the classification of solvent of the paint to be used for the upper layer, the hard form of the paint, the type of resin and the classification of solvent of the lower layer, the hard form of the paint, and the type of resin when two types of paints stored in the determination reference storage unit 134 are overcoated. For example, when the paint of the lower layer is an aqueous two-component paint, a weak solvent or a strong solvent may be applied to the upper layer. In such a case, the determination reference update unit updates the overcoating possibility information by newly adding this combination. As the “classification” of the solvent, subdivided classifications such as “one-component type”, “two-component type”, and the like may be adopted. For example, for “Strong solvent type”, “Strong solvent type: one-component type (moisture effect type)”, or “strong solvent type: two-component type (reaction curing type)”, and the like may be adopted, and for “Weak solvent type”, “one-component type”, “two-component type”, and “Aqueous” may be adopted. For example, the determination reference update unit updates the combination in each paint based on track record information indicating a result when it is determined as “impossible” based on the determination reference information as illustrated in FIG. 5B, but is actually “possible”, or when it is determined as “possible” but is actually “impossible”.

In addition, the determination reference update unit may update the determination reference based on a determination reference setting model that sets the determination reference based on the contained substances of each corresponding paint. In this case, the determination reference update unit may optimize the determination reference setting model through machine learning based on track record information indicating “possible” and “impossible” and the corresponding contained substances of each paint. In addition, a solubility parameter update unit that optimizes the solubility parameter of the paint or thinner based on the actual solubility of the paint or thinner may be further included.

In the first embodiment, an example has been described in which the paint information storage unit 133 stores the solvent classification of various paints in advance. However, the present invention is not limited to this example, and may include a solvent classification determination unit that determines whether the solvent classification is a weak solvent, a strong solvent, or an aqueous solvent based on a numerical range to which solubility parameters of various paints belong. For example, when the SP value of Hildebrand is adopted as the solubility parameter, the solvent classification determination unit may determine the paint to be overcoated as a weak solvent when the SP value is 14 MPa0.5 or more and less than 18 MPa0.5 , and may determine the paint to be overcoated as a strong solvent when the SP value is 18 MPa0.5 or more and less than 24 MPa. When the HSP value described above is adopted as the solubility parameter, the solvent classification determination unit may determine between a weak solvent and a strong solvent based on the HSP values of the three components of the paint to be overcoated.

In the first embodiment, the overcoating possibility determination unit 114 may determine whether the two paints can be overcoated based on a difference between values of solubility parameters of the two paints to be overcoated.

In each embodiment, a solubility parameter estimation unit that estimates the solubility parameter of the paint or thinner based on the thinner designated by the manufacturer of the paint or thinner or the solvent classification of a mixable paint may be included for the paint or thinner. For example, the solubility parameter estimation unit estimates and registers an approximate solubility parameter from the name of the paint or thinner (for example, a modified epoxy resin paint), the safety data sheet, and the like. Thereafter, when the composition of the thinner dedicated to the paint or the paint mixable with the thinner is determined, the solubility parameter estimation unit calculates and registers the solubility parameter again based on the composition. In addition, the solubility parameters of the paint and the thinner may be corrected based on a solvent having a known solubility parameter and a mixing degree when mixed with the paint.

Various functions of the cloud servers 1 and 3001 and the terminal devices 3 and 3003 according to the present invention can be implemented using a normal computer system without using a dedicated system. For example, the cloud servers 1 and 3001 and the terminal devices 3 and 3003 that execute the above-described processing may be configured by storing a program for executing the above-described operation in a non-transitory recording medium (such as a compact disc read only memory (CD-ROM)) readable by a computer system and distributing the program to a computer connected to a network, and installing the program in the computer system.

Any method of providing the program to the computer can be adopted. For example, the program may be uploaded to a bulletin board system (BBS) of a communication line and distributed to the computer via the communication line. Then, the computer activates the program and executes the program in the same manner as other applications under the control of an operating system (OS). As a result, the computer functions as the cloud servers 1 and 3001 and the terminal devices 3, 3003, and 4003 that execute the above-described processing.

Although the embodiments and modifications of the present invention have been described above, the present invention is not limited to these. The present invention includes those obtained by appropriately combining the embodiments and the modifications, and those obtained by appropriately modifying the embodiments and the modifications.

The present application is based on Japanese Patent Application No. 2023-135074 filed on Aug. 22, 2023 and Japanese Patent Application No. 2024-026223 filed on Feb. 26, 2024. The entire specification, claims, and drawings of Japanese Patent Application No. 2023-135074 and Japanese Patent Application No. 2024-026223 are incorporated herein by reference.

### Industrial Applicability

The present invention is suitable as a system used when a coating contractor performs a paint mixing operation.

### REFERENCE SIGNS LIST

1, 3001 cloud server
3, 3003, 4003 terminal device
101, 301 CPU
102, 302 main storage unit
103, 303 auxiliary storage unit
106, 306 communication unit
109, 309 bus
111 paint information acquisition unit
112 solubility parameter calculation unit
113 thinner specifying unit
114 overcoating possibility determination unit
115, 3115 paint-related information notification unit
131 solubility information storage unit
132 thinner information storage unit
133 paint information storage unit
134 determination reference storage unit
304 display unit
305 input unit
311 acceptance unit
312, 3312 paint information notification unit
313 paint-related information acquisition unit
314 display control unit
407 imaging unit
3116 mixing possibility determination unit
B11, B12 input field
GA1 overcoating determination target paint input screen image
GA2, GA3002, GA4002, GA5002 paint-related information notification image
GA3001 mixing possibility determination target paint input screen image
M21, M22, M23, M24, M25, M2111, M2112, M2121, M2122, M3111, M3112, M3121, M3122 message information
NW1 network
OB2011, OB2012, OB3011, OB3012, OB4011, OB4012, OB5011, OB5012 object image

1. A coating material-related information providing device comprising:
a coating material information acquisition unit that acquires target coating material information including first coating material information indicating a first coating material on a base side when two types of coating materials designated by a user are overcoated and second coating material information indicating a second coating material to be overcoated on the first coating material;
an overcoating possibility determination unit that determines whether it is possible to overcoat the second coating material on the first coating material based on at least one of: (a) a classification of a solvent contained in each of the first coating material and the second coating material, (b) a hard form of each of the first coating material and the second coating material, a type of resin contained in each of the first coating material and the second coating material, and (d) a solubility parameter of each of the first coating material and the second coating material;
a coating material specifying unit that identifies a third coating material that can be mixed with at least one of the first coating material and the second coating material based on the solubility parameter of the at least one of the first coating material and the second coating material; and
a coating material-related information notification unit that generates coating material-related information including overcoating possibility information indicating whether the overcoating is possible and third coating material information indicating the third coating material, and transmits the coating material-related information to a terminal device.

2. The coating material-related information providing device according to claim 1, wherein the overcoating possibility determination unit determines that overcoating is possible when the hard form of the paint and the type of the resin are the same between the first coating material and the second coating material, and at the same time the classification of the solvent contained in the first coating material and the classification of the solvent contained in the second coating material are the same, determines that overcoating is possible when the classification of the solvent contained in the first coating material is a strong solvent type and the classification of the solvent contained in the second coating material is a weak solvent type or an aqueous type, determines that overcoating is possible when the classification of the solvent contained in the first coating material is a weak solvent type and the classification of the solvent contained in the second coating material is an aqueous type, and determines that overcoating is possible when the classification of the solvent contained in the first coating material is an aqueous two-component type and the classification of the solvent contained in the second coating material is an aqueous type, a strong solvent type, or a weak solvent type.

3. The coating material-related information providing device according to claim 1, wherein the overcoating possibility determination unit selects different ranks for when a combination of the first coating material and the second coating material is the same as a specification defined by a manufacturer of at least one of the first coating material and the second coating material, when a combination of a classification of a resin system of the first coating material and a classification of a resin system of the second coating material is properly made, when the classification of a resin system recognized by the manufacturer of at least one of the first coating material and the second coating material is the same, and when the overcoating is impossible.

4. The coating material-related information providing device according to claim 1, wherein
the solubility parameter is a three-dimensional HANSEN solubility parameter including a dispersive power component, a polar component, and a hydrogen bond component, and
the coating material specifying unit specifies the third coating material having a solubility parameter corresponding to coordinates whose distance from coordinates corresponding to the solubility parameter of at least one of the first coating material and the second coating material is equal to or less than a preset reference distance in a three-dimensional space representing the solubility parameter.

5. The coating material-related information providing device according to claim 4, further comprising a solubility parameter calculation unit that calculates the solubility parameter based on a content rate of each of at least one type of contained substance included in the at least one of the first coating material and the second coating material.

6. A coating material related information providing system comprising:
a terminal device;
a coating material information acquisition unit that acquires target coating material information including first coating material information indicating a first coating material on a base side when two types of coating materials designated by a user are overcoated and second coating material information indicating a second coating material to be overcoated on the first coating material;
an overcoating possibility determination unit that determines whether it is possible to overcoat the second coating material on the first coating material based on at least one of: (a) a classification of a solvent contained in each of the first coating material and the second coating material, (b) a hard form of each of the first coating material and the second coating material, a type of resin contained in each of the first coating material and the second coating material, and (d) a solubility parameter of each of the first coating material and the second coating material;
a coating material specifying unit that specifies a third coating material that can be mixed with at least one of the first coating material and the second coating material based on the solubility parameter of the at least one of the first coating material and the second coating material; and
a coating material-related information notification unit that generates coating material related information including overcoating possibility information indicating whether the overcoating is possible and third coating material information indicating the third coating material and transmits the coating material-related information to the terminal device.

7. A coating material-related information providing method comprising:
a step of acquiring target coating material information including first coating material information indicating a first coating material on a base side when two types of coating materials designated by a user are overcoated and second coating material information indicating a second coating material to be overcoated on the first coating material;
a step of determining whether it is possible to overcoat the second coating material on the first coating material based on at least one of: (a) a classification of a solvent contained in each of the first coating material and the second coating material, (b) a hard form of each of the first coating material and the second coating material, a type of resin contained in each of the first coating material and the second coating material, and (d) a solubility parameter of each of the first coating material and the second coating material;
a step of specifying a third coating material that can be mixed with at least one of the first coating material and the second coating material based on the solubility parameter of the at least one of the first coating material and the second coating material; and
a step of generating coating material-related information including overcoating possibility information indicating whether the overcoating is possible and third coating material information indicating the third coating material and transmitting the coating material-related information to a terminal device.

8. A non-transitory computer-readable recording medium storing a program, the program causing a computer to function as:
a coating material information acquisition unit that acquires target coating material information including first coating material information indicating a first coating material on a base side when two types of coating materials designated by a user are overcoated and second coating material information indicating a second coating material to be overcoated on the first coating material;
an overcoating possibility determination unit that determines whether it is possible to overcoat the second coating material on the first coating material based on at least one of: (a) a classification of a solvent contained in each of the first coating material and the second coating material, (b) a hard form of each of the first coating material and the second coating material, a type of resin contained in each of the first coating material and the second coating material, and (d) a solubility parameter of each of the first coating material and the second coating material;
a coating material specifying unit that specifies a third coating material that can be mixed with at least one of the first coating material and the second coating material based on the solubility parameter of at least one of the first coating material and the second coating material; and
a coating material-related information notification unit that generates coating material-related information including overcoating possibility information indicating whether the overcoating is possible and third coating material information indicating the third coating material and transmits the coating material-related information to a terminal device.
